(19) United States
(12) Patent Application Publication
(10) Pub. No.: US 2007/0176317 A1
(43) Pub. Date: Aug. 2, 2007

(54) Semiconductor device and method of manufacturing thereof

(76) Inventors: Yoshitsugu Morita, Chiba Prefecture (JP); Katsutoshi Mine, Chiba Prefecture (JP); Fumio Mitajima, Nagano Prefecture (JP)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/550,839

(22) PCT Filed: Mar. 25, 2004
(86) PCT No.: PCT/JP04/04228

§ 371 Date: Nov. 13, 2006

(30) Foreign Application Priority Data
Mar. 25, 2003 (JP) 2003-083834

(51) Int. Cl. B29C 70/70; B29C 70/88

(52) U.S. Cl. 264/138; 264/272.17; 264/320; 264/331.11; 264/338

(57) ABSTRACT

A method of manufacturing a semiconductor device sealed with silicone rubber, characterized by 1) placing an unsealed semiconductor device into a mold, 2) thereafter filling in spaces between the mold and the semiconductor device with a sealing silicone rubber composition, and 3) subjecting the composition to compression molding. By the utilization of this method, a sealed semiconductor device is free of voids, and a thickness of a sealing silicone rubber can be controlled.

### TECHNICAL FIELD

This invention relates to a method of manufacturing semiconductor devices sealed with a silicone rubber and to semiconductor devices produced by the aforementioned method.

### BACKGROUND ART

Sealing of semiconductor devices is carried out with the use of a transfer-mold method, screen-printing method with liquid sealing resin, or a potting method with liquid sealing resin. The recent trend towards miniaturization of semiconductor devices demands that electronic devices be smaller in size, thinner in thickness, and allow resin sealing of packages as thin as 500 μm or thinner.

If a transfer-mold method is employed in resin sealing of thin packages, the thickness of the sealing resin could be precisely controlled, whereas there are problems that vertical displacements of semiconductor chips occur in a flow of a liquid sealing resin, or breakage of wires and contact between the wires occur because of deformations of bonding wires connected to semiconductor chips under the effect of pressure in the flow of the liquid sealing resin.

On the other hand, although potting or screen-printing with a liquid sealing resin to some extent protects the bonding wires from breakage and mutual contact, these methods make accurate control of sealing-resin coatings more difficult and can easily lead to formation of voids.

It was proposed to solve the above problems and to manufacture a resin-sealed semiconductor device by placing an unsealed semiconductor device into a mold, filling spaces between the semiconductor device and the mold with a moldable resin, and curing the resin by using compression-molding (see Japanese Laid-Open Patent Application Publication (Kokai) (hereinafter referred to as “Kokai”) Hei 8-244064, Kokai Hei 11-77733, and Kokai 2000-277551).

However, due to thinning of semiconductor chips that occurs with miniaturization of semiconductor elements, the methods disclosed in Kokai Hei 8-244064, Kokai Hei 11-77733, and Kokai 2000-277551 increase warping of the semiconductor chips and printed-circuit boards and may lead to damaging of semiconductor devices and to worsening of their performance characteristics.

It is an object of the present invention to provide a method of manufacturing a semiconductor devices sealed with a silicone rubber, which in case of sealing produces sealed semiconductor devices that are free of voids, can be produced with precision control of the sealing-rubber thickness, do not have broken or contacting bonding wires, and are characterized by minimized warping of the semiconductor chips and printed-circuit boards. It is another object to provide sealed semiconductor devices with the aforementioned characteristics.

### DISCLOSURE OF INVENTION

The method of the present invention is characterized by

1) placing an unsealed semiconductor device into a mold,

2) thereafter filling in spaces between the mold and the semiconductor device with a sealing silicone rubber composition, and

3) subjecting the composition to compression molding.

The sealed semiconductor device of the present invention is the one produced by the above method.

### BRIEF DESCRIPTION OF DRAWINGS

FIG. 1 illustrates main structural units of compression molding machine suitable for realization of the method of the present invention.

FIG. 2 illustrates sealing conditions of a semiconductor device sealed with the use of a compression molding machine utilized for realization of the method of the invention.

FIG. 3 is a sectional view of a semiconductor device in accordance with Practical Example 1.

FIG. 4 is a sectional view of a semiconductor device in accordance with Practical Example 2.

FIG. 5 is a sectional view of a semiconductor device in accordance with Practical Example 3.

FIG. 6 illustrates the structure of the compression molding machine used for the production of semiconductor devices by the method of the invention.

FIG. 7 is an example of a three-dimensional view of a semiconductor device of the invention.

### REFERENCE NUMBERS

10 semiconductor chip

12 printed-circuit board

14 sealing silicone rubber

16 semiconductor device

20 fixed platen

22 lower base

23 lower mold

24 heater

26 lower clamp stopper

30 moveable platen

32 upper base

33 upper holder

34 upper mold

34a recess of the cavity

36 clamper

36a, 36b airports

37 spring

38 heater

39 upper clamp stopper

40a, 40b release films

42a, 42b feed rollers

44a, 44b take-up rollers

46 guide roller

48 static charge remover

50 sealing silicone rubber composition

70 semiconductor device sealed with the silicone rubber

72 sealing silicone rubber

### DETAILED DESCRIPTION OF THE INVENTION

The method of the invention comprises 1) placing an unsealed semiconductor device into a mold, 2) filling in spaces between the mold and the semiconductor device with a sealing silicone rubber composition, 3) subjecting the aforementioned silicone rubber composition to compression molding. A press-molding machine with a mold suitable for realization of the method may be a conventional compression molding machine that comprises: a upper mold and a lower mold that form a mold cavity for accommodating the aforementioned semiconductor device and for filling this cavity with a sealing silicone rubber composition; a clamper for application of pressure; and a heater for curing the aforementioned sealing silicone rubber composition by heating. Examples of such pressure molding machines are described, e.g., in Kokai Hei 8-244064, Kokai Hei 11-77733, and Kokai 2000-277551. Among these, the machine disclosed in Kokai 2000-277551 is most preferable as it has a very simple construction.

More specifically, in the press-molding machine of Kokai 2000-277551, an unsealed semiconductor device is placed into a lower mold, then a sealing silicone rubber composition is fed to the space between the upper mold and the semiconductor device, the latter is clamped between the upper mold and lower mold, and the sealing silicone rubber composition is subjected to compression molding. The aforementioned compression molding machine is provided with a clamper which is formed into a frame-shape body that encloses side faces of the upper mold and is capable of sliding upward and downward in the opening and closing directions along the aforementioned side faces so that, when the mold is open and the lower end of the clamper is downwardly projected from the lower resin molding face of the upper mold, it is always biased downwardly. In cases where the upper mold and the lower mold come into direct contact with a silicone rubber composition, it is recommended to coat the working surfaces of the mold with a fluoro-type resin. In particular, such compression molding machines are provided with feeding mechanisms for feeding films releasable from the mold and from the sealing rubber to the working position of the upper mold. Since in the aforementioned compression molding machine the semiconductor device is sealed through a release film, no resin is stuck on the resin molding face of the mold, the resin molding space is securely sealed by the release film, and molding can be carried out without forming resin flash.

The compression molding machine is also provided with another release-film feeding mechanism for a film peelable from the mold and the sealing rubber for feeding the aforementioned release film to cover a surface of the lower mold intended for supporting an unsealed semiconductor device. The machine is provided with a release film suction mechanism which fixes the release film on the lower end face of the clamper by air suction and fixes the release film on the inner surface of the mold space defined by the working surface of the upper mold and the inner surface of the clamper. This is achieved by sucking air from the inner bottom surface of the resin sealing area. Such an arrangement reliably holds the release film on the working surfaces of the mold. The release-film suction mechanism further comprises an air port open in the lower end face of the clamper and an air port open in an inner face of the clamper and communicating with an air channel formed between the inner surface of the clamper and the side surface of the upper mold. It is also possible to provide each aforementioned air port with an individual air-suction mechanism. The working surface of the upper mold may have cavities for molding separate elements that correspond to positions of semiconductor chips on the semiconductor device. Similarly, the working surface of the lower mold also may have cavities for molding separate elements that correspond to positions of semiconductor chips on the semiconductor device. The upper mold is capable of moving in the mold opening and closing directions and is biased toward the lower mold. The lower mold has in its working surface an overflow cavity for accumulating the sealing silicone rubber composition overflowed from the resin molding space when the semiconductor device is subjected to sealing. The machine is also provided with a gate channel that connects the overflow cavity with the sealing area in the clamping surface of the clamper that is pressed against the semiconductor device.

In operation, an unsealed semiconductor device is placed into the lower mold, a sealing silicone rubber composition is fed into the space between the upper mold and the aforementioned semiconductor device, the rubber molding area is coated with a film peelable from the mold and the sealing rubber, and the semiconductor device, together with the sealing silicone rubber composition, is clamped between the upper mold and the lower mold. At this moment, the clamper moves along the side faces of the molding zone in the direction of mold opening and closing and is biased downward to the upper mold so as to project the lower end thereof below the resin molding face of the upper mold. Then the clamper comes into contact with the semiconductor device, the periphery of the sealing zone is sealed, and while the upper mold and the lower mold are gradually moved towards each other, the sealing silicone rubber composition fills the molding space. The clamper encloses the resin molding space in frame-like manner that during the clamping operation. The movement of the upper mold and the lower mold is discontinued at a clamping position, and, as a result, the molding space is fully filled with the silicone rubber composition, and sealing of the semiconductor device is completed.

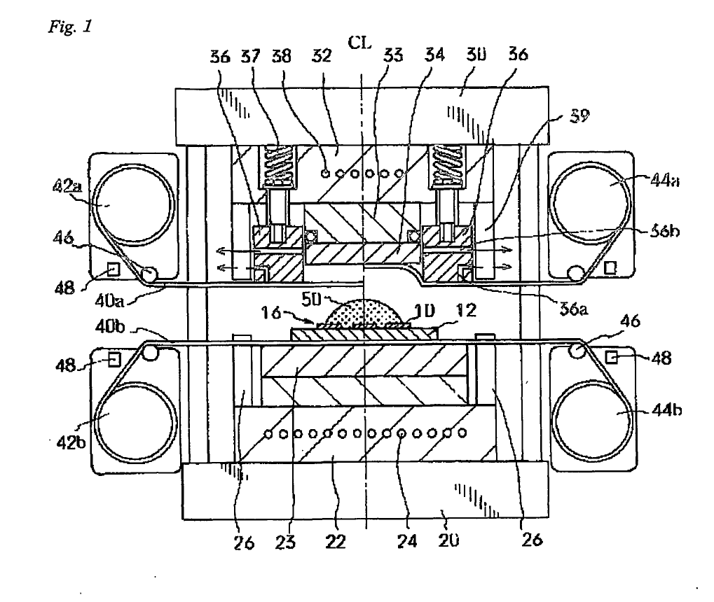

FIG. 1 illustrates main structural units of a compression molding machine suitable for realization of the method of the present invention. In this drawing, reference numeral 20 designates a fixed platen, 30 is a moveable platen. Both platens are connected to and supported by a press unit. The press unit may be electrically or hydraulically driven and performs a sealing operation by moving the moveable platen 30 in a vertical direction.

Reference numeral 22 designates a lower base, which is connected to the fixed platen 20. A setting section is formed in an upper face of a lower mold 23. An unsealed semiconductor device 16 to be sealed by the method of the present invention comprises a printed-circuit board 12 and a plurality of semiconductor chips 10, which are spaced from each other and are arranged on the printed-circuit board 12 in the longitudinal and transverse directions. The unsealed semiconductor devices 16 are placed into the lower mold 23. Reference numeral 24 designates heaters attached to the lower base 22. The heaters 24 heat the lower mold 23 and the unsealed semiconductor device 16 set in the lower mold 23. Reference numeral 26 designates lower clamp stoppers, which are installed in the lower base 22 and define clamping positions of the upper mold 34 top and the lower mold 23.

An upper base 32 is fixed to the moveable platen 30. The device contains an upper holder 33, which is fixed to the upper base 32. The upper mold 34 is fixed to the upper holder 33. In the present embodiment of the method of the invention, the semiconductor chips 10 are provided on one side face of the printed-circuit board 12, and the semiconductor chips 10 in the printed-circuit board 12 are sealed and made flat on the sealed surface. For this purpose, the working surface of the upper mold 34 is also made flat over the entire surface of the sealing zone. A clamper 36 provided in the device is formed into a frame-shaped configuration and encloses side faces of the upper mold 34 and the upper holder 33. The clamper 36 is attached to the upper base 32 and is capable of vertically moving with respect thereto. Normally, the clamper 36 is biased toward the lower mold 23 by springs 37. The working surface of the upper mold 34 is slightly withdrawn from the edge of the clamper 36, so that a sealing zone is formed between the inner face of the clamper 36 and the working surface of the upper mold 34 in the closed position of the mold. The clamper 36 may be biased by means other than the spring 37, e.g., by an air cylinder or the like.

Reference numeral 38 designates heaters attached to the upper base 32. The heaters 38 heat the upper mold 34 and the upper holder 33 so that the semiconductor device 16 is heated when the mold is closed. The device is provided with upper clamp stoppers 39, which are installed in the upper base 32. The upper clamp stoppers 39 and the lower clamp stoppers 26 are aligned with each other so that, when the mold is closed, the mating end faces of the stoppers come into mutual contact. When the moveable platen 30 is moved downward by the press unit, the upper clamp stoppers 39 contact the lower clamp stoppers 26 at the clamping position of the mold. The thickness of the rubber layer in the sealing zone is defined by the aforementioned clamping position.

Reference numerals 40a and 40b designate release films which are formed as elongated belts having a width suitable for covering the working areas of the upper mold 34 and lower mold 23. The release films are used for coating the sealing surfaces of the working zone so as to exclude direct contact of the working surfaces of the mold with the silicone rubber composition. The release films 40a and 40b are made of a soft material having a uniform strength and easily deformable in order to cover the recesses and projections on the working surfaces of the mold. At the same time, the material of the films should possess thermal resistance sufficient to withstand molding temperatures and should be easily peelable from the sealing silicone rubber and the mold. Examples of such films are films made from polytetrafluoroethylene (PTFE) resin, a copolymer of ethylene and tetrafluoroethylene (ETFE), a copolymer of tetrafluoroethylene and perfluoropropylene (FEP), polyvinylidenefluoride resin, or similar fluoro-resin films; polyethyleneterephthalate (PET) resin films and polypropylene films (PP).

If only one side of the printed circuit board 12 is sealed by the method of the present invention, the film, which is brought into contact with the silicone rubber, is the release film 40a that is fed to the upper mold 34. Additional feeding of the release film 40b to the working surface of the lower mold 23 will improve reliability of sealing and exclude formation of flashes by effectively absorbing non-uniformities in the thickness of the printed circuit board 12 due to compressibility and elasticity of the release film 40b. In principle, however, sealing can be carried out with the supply only of the release film 40a to the upper mold 34 alone.

Reference numerals 42a and 42b designate feeding rollers for feeding release films 40a and 40b, while 44a and 44b designate take-up rollers for the release films 40a and 40b. As shown in the drawing, the film feeding rollers 42a, 42b and film take-up rollers 44a, 44b are located on opposite sides of the mold. The film feeding roller 42a of the upper mold and the take-up roller 44a are attached to the moveable platen 30, while the film feeding roller 42b and the film take-up roller 44b are attached to the fixed platen 20. In such an arrangement, the release films 40a and 40b move from one side to the other side of the mold. The film feeding roller 42a and the take-up roller 44a of the upper mold are vertically moved together with the moveable platen 30. Reference numeral 46 designates guide rollers, and 48 designates static charge removers, namely, ionizers, that remove electrostatic charge from the release films 40a and 40b.

The release film 40a fed to the upper mold 34 is fixed onto the upper mold 34 and held by air suction. The clamper 36 has air ports 36a that are opened in the lower end face of the clamper 36 and air ports 36b opened in the inner side surfaces of the clamper 36. The air ports 36a are connected to a suction unit located outside the mold. A seal ring is installed in the upper holder 33 on the sliding inner surface of the clamper to prevent leakage when air is sucked through the air ports 36b. A space is formed between the side faces of the upper mold 34, side faces of the upper holder 33, and inner faces of the clamper 36 for an air channel, so that under the effect of suction of air through the air ports 36b the release film 40a can be applied and fixed onto the inner surfaces of the molding zone, which is formed by the upper mold 34 and the clamper 36. In addition to the suction action, the suction unit connected to the air ports 36a and 36b may generate compressed air. Supply of compressed air to the air ports 36a and 36b will facilitate separation of the release film 40a from the working surfaces of the mold.

The following is a description of the method of the invention for sealing a semiconductor device with the use of the above-described mold. In FIG. 1, in the side of the mold to the left from the center line CL, the movable platen 30 is shown in an open state, in which it is located at its uppermost position. In this state, the release films 40a and 40b are newly fed onto the working surfaces of the mold, while a semiconductor device 16 is placed into the lower mold 23. The semiconductor device 16 is laid onto the release film 40b that covers the surface of the lower mold 23.

In FIG. 1, the side of the mold to the right from the center line CL shows a state, in which the release film 40a is attached by suction to the upper mold 34 and the lower end face of the clamper 36. The release film 40a is fed to the working surface of the mold, the air is sucked through the air ports 36a and 36b, the release film 40a is placed and fixed onto the lower end face of the clamper 36, and at the same time the release film 40a is fitted and fixed on the inner surfaces of the clamper 36 and the working surface of the upper mold 34. Since the release film 40a is sufficiently soft and stretchable, under effect of suction it can tightly fit to recesses on the inner surface of the clamper 36 and the working surface of the upper mold 34. The air ports 36a on the end face of the clamper 36 are spaced from each other at predetermined distances and distributed over periphery of the upper mold 34.

The release film 40a is fixed by air suction on the upper mold 34. A sealing silicone rubber composition 50 is supplied onto the printed-circuit board 12 of the semiconductor device 16. It is recommended to supply the sealing silicone rubber composition in an amount corresponding to the inner volume of the sealing space by using a dispenser or a similar dosing device.

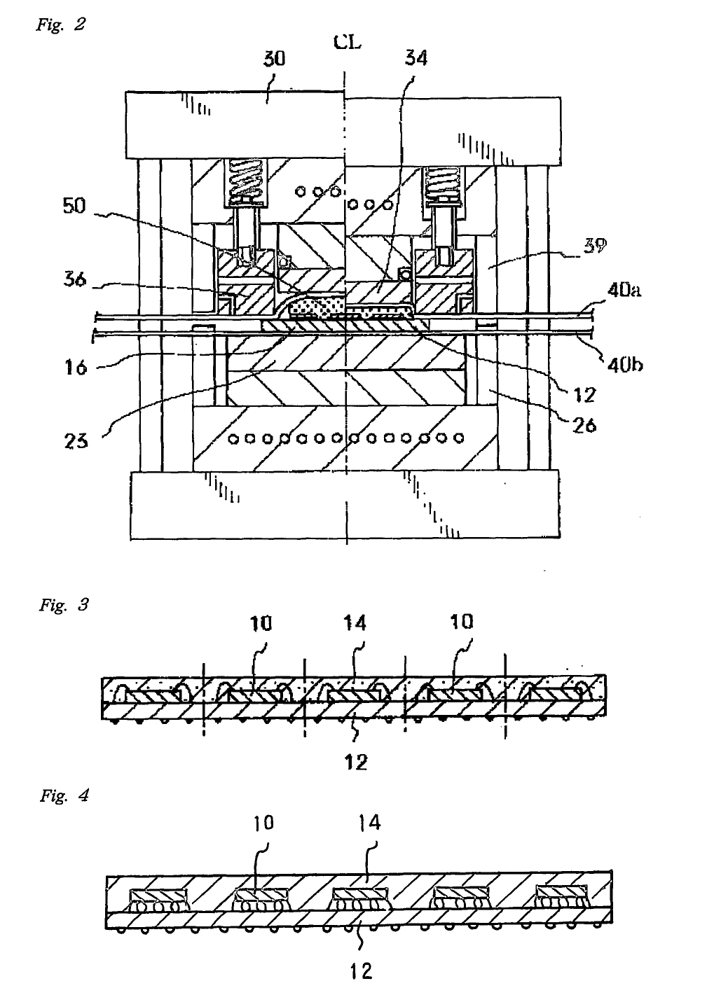

FIG. 2 illustrates the mold in the state where the semiconductor device 16 is clamped between the upper mold 34 and the lower mold 23. The part of the mold that is shown in this drawing to the left from the center line CL illustrates the state, in which the upper mold 34 is moved downward and the lower end face of the clamper 36 is pressed against the printed-circuit board 12 of the semiconductor device 16. The upper mold 34 did not yet reach the position of complete clamping, but since the periphery of the molding space is closed and sealed by the clamp 36, the sealing silicone rubber composition 50 is compressed by the upper mold 34 and begins to fill the molding space. In FIG. 2, the parts on the right side of the center line CL are shown with the upper mold 34 shifted downward to the final clamping position. In this position, the end faces of the upper clamp stoppers 39 are in contact with the end faces of the lower clamp stoppers 26. The clamping force moves the clamper 36 upward against the elasticity of the springs 37, so that the sealing silicone rubber composition 50 in the molding space acquires a predetermined height.

By moving the upper mold 34 downward to the clamping position, the molding space is reduced to a desired height, and the sealing silicone rubber composition 50 used for sealing fills the entire molding space. As shown in FIG. 2 on the left from the center line CL, a small gap is still left between the release film 40a and the corner of the upper mold 34. However, this gap disappears when the upper mold 34 descends to the lowermost position, so that the sealing silicone rubber composition 50 completely fills the entire molding space.

Since the periphery of the molding space is closed and reliably sealed by the clamper 36 via the release film 40a, no leakage occurs from the molding space. In the case where small steps are formed on the surface of the printed-circuit board 12, e.g., by wire patterns, these small projections can be absorbed by pressing via the release film 40a, so that no sealing silicone rubber composition leaks outside the molding space when the mold is in a clamped state. Due to its resiliency in the thickness direction, the release film 40b on the lower side of the printed-circuit board 12 also can absorb deviations in the thickness of the semiconductor device 16 and thus further contribute to reliability of sealing.

After the mold is closed and the sealing silicone rubber composition 50 is cured, the mold is opened and the sealed semiconductor device 70 is removed from the mold. Since sealing was carried out through the release films, the sealing silicone rubber composition 50 does not stick to the working surfaces of the mold. The release films 40a and 40b can be easily peeled off from the mold, so that the sealed semiconductor device 70 can be easily removed from the open mold. Separation of the release film 40a from the working surfaces of the mold can be facilitated by blowing air through the air-holes 36a and 36b. After the mold is open, the feed rollers 42a, 42b and the take-up rollers 44a and 44b are activated, and the release films 40a and 40b are removed from the mold together with the sealed semiconductor device 70.

Semiconductor devices 70 sealed by the method of the present invention are shown in FIGS. 3, 4, and 5. Since the upper mold 34 has a flat working surface, the upper face of the sealed product is also made flat. Individual sealed semiconductor devices are obtained by cutting the printed circuit board along the center lines shown in the drawings between the neighboring semiconductor chips 10. Cutting can be carried out by a dicing saw, a laser cutter, etc.

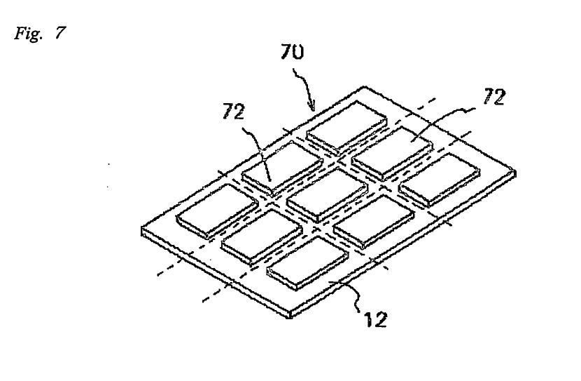

As shown in FIG. 6, in accordance with the method of the present invention, a plurality of cavities 34a that correspond to positions of respective semiconductor chips 10 on the printed-circuit board 12 are formed in the working surface of the upper mold 34. In other words, each semiconductor chip 10 can be sealed in the individual cavity 34a.

Semiconductor chips sealed with silicone rubber 70 by the above method are shown in FIG. 7. Such semiconductor devices 70 also can be separated into individual products by cutting through the sealing silicone rubber 72 and the printed-circuit board along the lines between the adjacent semiconductor chips. Cutting can be carried out by a dicing saw, a laser cutter, etc.

There are no special restrictions with regard to the sealing silicone rubber composition and mechanism of curing. However, the following sealing silicone rubber compositions can be recommended for compression molding without formation of by-products: a silicone rubber composition curable by a hydrosilylation reaction, silicone rubber composition curable with the use of organic peroxide, and free radical-curing silicone rubber composition. The most preferable of these compositions is the silicone rubber composition curable by a hydrosilylation reaction. For example, such a hydrosilylation reaction-curable silicone rubber composition may contain at least the following components: (A) an organopolysiloxane having at least two alkenyl groups per molecule; (B) an organohydrogenpolysiloxane having at least two silicon-bonded hydrogen atoms per molecule; (C) a platinum catalyst, and (D) a filler. The composition may be additionally combined with a pigment and a reaction inhibitor. Such a composition is easily obtainable. In addition to a protective-agent function for semiconductor chips and their interconnects, the sealing silicone rubber composition of the present invention may be used for the formation of isolation or buffering layers on the semiconductor chips and printed-circuit boards.

It is recommended that a silicone rubber prepared by curing the aforementioned silicone rubber composition have complex elastic modulus of 1 GPa or less, and especially for protecting semiconductor chips from generation of stress, preferably 100 MPa or less.

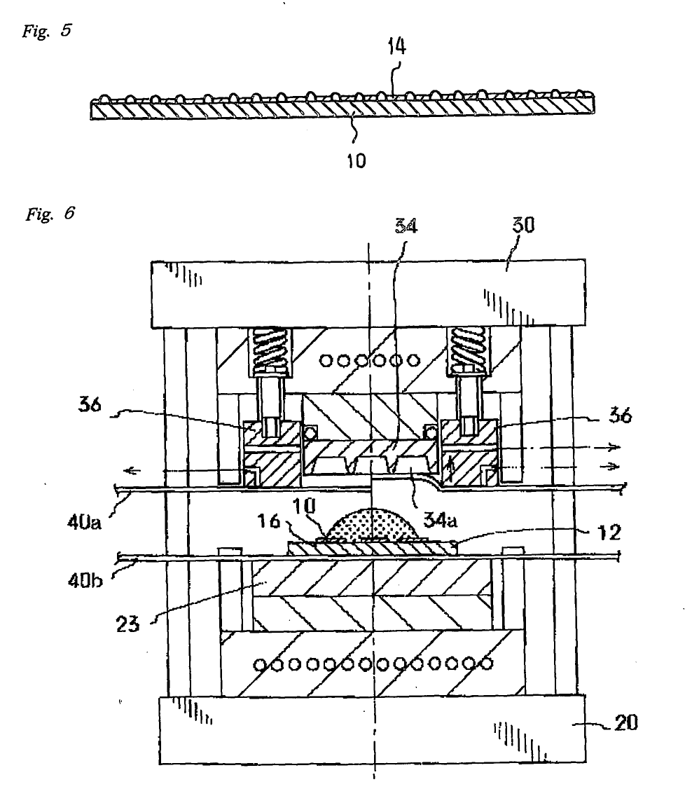

Semiconductor devices suitable for sealing by the method of the invention may comprise printed-circuit boards with semiconductor chips, semiconductor chips electrically connected to printed-circuit boards, or semiconductor wafers prior to cutting into individual semiconductor devices. FIGS. 3 and 4 illustrate wire-bonded semiconductor devices in the form of semiconductor chips on their printed-circuit board and semiconductor chips on printed-circuit boards with a plurality of lead wires. More specifically, in the embodiment of the semiconductor device shown in FIG. 3, the semiconductor chips 10 are first attached by a die-bond agent to the printed circuit board 12 made from a polyimide resin, epoxy resin, BT resin, or ceramic, and then they are bond-wired to contacts of the printed-circuit board by gold or aluminum wires. In the embodiment of the semiconductor device shown in FIG. 4, the semiconductor chips 10 are electrically connected to the contacts of the printed-circuit board via solder balls or bumps. In the devices of the last-mentioned type, an additional function of using the solder balls or bumps is introduction of an underfill agent. Such an underfill agent may comprise, e.g., a curable epoxy resin composition or a curable silicone composition. In the embodiments of semiconductor devices of FIGS. 3 and 4, to connect the semiconductor devices with another printed-circuit board after sealing with the silicone rubber, external electrodes, e.g., solder balls are provided on the lower side of the printed-circuit board that supports the semiconductor chips 10. Where a plurality of semiconductor chips located on a common printed-circuit board are sealed simultaneously, the devices can be separated into individual units by sawing or chopping out. FIG. 5 illustrates a wafer-level CSP (Chip-Scale Packaging).

If sealing of a semiconductor device with a sealing silicone rubber composition is carried out in the aforementioned compression molding machine with direct contact of the composition with the working surface of the mold, the aforementioned surface is coated with a slimy substance, It is, therefore, recommended to perform compression molding via the aforementioned release films. The use of the release films makes it possible to conduct the sealing operation in a continuous mode and extend the intervals between the mold cleanings. This results in an increased productivity.

There is no special restrictions with regard to compression-molding conditions suitable for the method of the invention. However, to decrease stress in the printed-circuit board and semiconductor chip, it is recommended to chose the heating temperature within the range of 60° C. though 150° C. Furthermore, preheating of the mold may improve the compression-molding cycle time. The compression-molding conditions can further be controlled by selecting sealing silicone rubber compositions of different types. Spreading properties of the sealing silicone rubber composition can be controlled by applying the composition onto a printed-circuit board that retains the remaining heat obtained from the lower mold.

The following is the description of some properties of a semiconductor device produced by the above-described method of the present invention. Since this semiconductor device does not have voids in the sealing rubber material, it is free of external defects and is not subject to decrease in moisture-resistant properties. Furthermore, due to the fact that the sealing rubber layer can be precisely controlled, it becomes possible to make the semiconductor device smaller in size and thinner in thickness. Prevention of electrical contact between the bonding wires, elimination of wire breakage, and decrease in warping of the semiconductor chips and printed-circuit board improves reliability of the products and broaden the fields of their practical application.

### EXAMPLES

The method of manufacturing a semiconductor device and the semiconductor device of the invention will now be described in more detail with reference to practical and comparative examples. The procedures used for evaluating properties of the semiconductor devices are described below.

[Appearance and Filling]

The surfaces of the semiconductor devices sealed with a silicone rubber or cured epoxy resin were inspected by visual observation. Smooth surfaces were designated by symbol: ◯; surfaces with partial unevenness were designated by symbol: Δ; and completely uneven surfaces were designated by symbol: X.

[Warping]

Warping was evaluated by securing long peripheral sides of a printed-circuit board sealed with the silicone rubber or epoxy resin prior to cutting the printed-circuit board into individual semiconductor devices, and measuring the height in other areas of the printed-circuit board.

Silicone rubber compositions used in the subsequent practical examples were represented by a silicone rubber composition (A) (the product of Dow Corning Toray Silicone Co., Ltd., trademark TX-2287-2) and a silicone rubber composition (B) (the product of Dow Corning Toray Silicone Co., Ltd., trademark TX-2287-4). Characteristics of these compositions are shown in Table 1. Viscosity of each silicone rubber composition was measured with a BS-type rotary viscometer (the product of Tokimec Co., Ltd., model BS, Rotor No. 7, frequency of rotation: 10 rpm). The measured values corresponded to viscosity 25° C. The silicone rubber was formed by subjecting the silicone rubber composition to compression-molding for 3 min. at 140° C. and under load of 30 Kgf/cm² and then heat-treating it in an oven at 150° C. for 1 hour. A composite modulus of elasticity of the obtained rubber was measured with the use of a viscoelasticity measurement instrument (shear frequency: 1 Hz; distortion factor: 0.5%). Measured values corresponded to 25° C. A coefficient of thermal expansion of the silicone rubber was measured within the range of temperatures between 50° C. and 150° C. by means of a thermal mechanical analyzer (TMA).

TABLE 1

| | | Silicone Rubber Composition | |
|---|---|---|---|
| | | A | B |
| Prior to | Appearance | Black-Paste | Black-Paste |
| Curing | | Like | Like |
| | Viscosity (Pa · s) | 280 | 150 |
| After | Appearance | Black-Rubber | Black-Rubber |
| Curing | | Like | Like |
| | Hardness | 70 | 90 |
| | (Type A Durometer) | | |
| | Complex elastic | 4 | 20 |
| | modulus (MPa) | | |
| | Coefficient of Thermal | 170 | 170 |
| | Expansion (ppp/° C.) | | |

### Practical Example 1

A semiconductor device produced in this example is shown in FIG. 3. More specifically, semiconductor chips 10 having dimensions of 8 mm×14 mm were applied via a 35 μm-thick epoxy die-bond agent layer (not shown) onto a polyimide-resin printed-circuit board 12 having dimensions of 70 mm×160 mm (18 μm-thick copper foil was laminated onto one side of a 75 μm-thick polyimide film via a 17 μm-thick epoxy-resin adhesive layer; a circuit pattern was formed from the copper foil; except for the areas of the circuit pattern, the rest of the printed-circuit 12 board surface was coated with a photosensitive solder mask). Bumps (not shown) of the semiconductor chips 10 and elements of the circuit pattern were then electrically connected by wire bonding with the use of 48 gold bonding wires. Fifty four semiconductor chips supported by the printed-circuit board were divided into three groups of 18 chips each and were connected to their respective circuit patterns.

Predetermined areas of the polyimide-resin printed-circuit board 12 with semiconductor chips 10 was coated at room temperature with a hydrosilylation reaction-curable silicone rubber composition (A) having the total weight of 20 g, and then the printed-circuit board was placed into the lower mold of a compression molding machine of the type shown in FIG. 1. The lower mold and the upper mold of the molding machine were then moved towards each other (to protect the mold from contamination and to improve release of the silicone rubber from the mold, a tetrafluoroethylene release film was tightly attached to the inner surface of the upper mold by air suction). When the mold was closed with the printed-circuit board squeezed in it, compression-molding was carried out for 3 min with application of a 30 kgf/cm² load at 140° C. The mold was opened, the sealed semiconductor device was removed from the mold, and heat-treated for 1 hour in an oven at 150° C. The obtained semiconductor device was sealed with a 400 μm-thick layer of the silicone rubber. The coating had a smooth surface free of voids; the appearance and filling were evaluated as grade ◯. Warping was measured as 0.05 mm.

### Practical Example 2

A semiconductor device produced in this example is shown in FIG. 4. More specifically, a solder paste was applied by printing onto bump connection portions (not shown) of a printed-circuit board 12 made from a glass-fiber-reinforced epoxy resin and having dimensions of 45 mm×175 mm (18 μm-thick copper foil was laminated onto one side of a 90 μm-thick glass-fiber-reinforced film via a 18 μm-thick epoxy-resin adhesive layer; circuit patterns were formed from the copper foil; except for the areas of the circuit pattern, the rest of the printed-circuit board surface was coated with a photosensitive solder mask). Bonding-pad areas of the 6 mm×6 mm semiconductor chips 10 and their solder-paste portions were aligned and the printed-circuit board 12 was introduced into a reflow furnace where the solder was heated and fused whereby the semiconductor chips 10 and the circuit patterns were electrically connected via solder bumps (not numbered). An epoxy resin underfill agent (not numbered) was applied at room temperature between the semiconductor chips 10 and the printed-circuit board 12, the underfill was subjected to stepped heating and then was finally cured by heating for 3 hours at 180° C. One hundred eight semiconductor chips 10 supported by the printed-circuit board 12 were divided into three groups. Solder bumps had a diameter of 300 μm. Each semiconductor chip 10 contained 112 solder bumps.

Predetermined areas of the printed-circuit board 12 made from a glass-fiber-reinforced epoxy resin were coated at room temperature with a hydrosilylation reaction-curable silicone rubber composition (A) having the total weight of 10 g, and then the printed-circuit board 12 was placed into the lower mold 23 of a compression molding machine of the type shown in FIG. 1. The lower mold 23 and the upper mold 34 of the molding machine were then moved towards each other (to protect the mold from contamination and to improve release of the silicone rubber from the mold, a tetrafluoroethylene release film was tightly attached to the inner surface of the mold top by air suction), and then, in a closed state of the mold with the printed-circuit board 12 squeezed in it, compression molding was carried out for 2 min. with application of a 30 kgf/cm² load at 120° C. The mold was opened, the sealed semiconductor device was removed from the mold, and heat-treated for 1 hour in an oven at 150° C. The obtained semiconductor device was sealed with a 230 μm-thick layer of the silicone rubber 70. The coating had a smooth surface free of voids; the appearance and filling were evaluated as grade ◯. Warping was measured as 0.05 mm.

### Practical Example 3

A semiconductor device 70 produced in this example is shown in FIG. 5. More specifically, after forming a redistribution layer (not shown) and a buffer layer (not shown) on the wafer surface in a 8″-diameter, 300 μm-thick wafer-level CSP, solder balls (not numbered) were formed for connection to an external circuit. Two grams of a hydrosilylation reaction-curable silicone rubber composition (B) were then applied onto the aforementioned wafer surface at room temperature, and the wafer was placed into the lower mold 23 of the compression molding machine of the type shown in FIG. 1. The lower mold 23 and the upper mold 34 of the molding machine were then moved towards each other (to protect the mold from contamination and to improve release of the silicone rubber from the mold, a tetrafluoroethylene release film was tightly attached to the inner surface of the mold top by air suction), and then, in a closed state of the mold with the printed-circuit board 12 squeezed in it, compression molding was carried out for 2 min. with application of a 30 kgf/cm² load at 120° C. The mold was opened, the sealed semiconductor device was removed from the mold and heat-treated for 1 hour in an oven at 150° C. The obtained semiconductor device was sealed with a 400 μm-thick layer of the silicone rubber 70. The coating had a smooth surface free of voids; the appearance and filling were evaluated as grade ◯. Warping was measured as 0.2 mm.

### Comparative Example 1

A semiconductor device was produced by the same method as in Practical Example 1, except that a liquid-form curable epoxy resin composition (the product of Hitachi Chemical Co., Ltd., trademark CEL-C-7400) with characteristics shown in Table 2 was used instead of a hydrosilylation reaction-curable silicone rubber composition (A) used in Practical Example 1. Compression molding was carried out for 5 min. under the load of 30 kgf/cm² at a temperature of 170° C. with subsequent heat treatment for 1 hour in an oven at 150° C. The obtained semiconductor device was sealed with a 230 μm-thick epoxy resin coating on the surface of the semiconductor chip. The surface of the epoxy resin coating was free of voids and was classified as grade ◯. However, warping on the surface of the aforementioned sealing epoxy resin coating was as high as 7 mm.

TABLE 2

| | | Liquid curable epoxy resin |
|---|---|---|
| | | composition |
| Prior to | Appearance | Black paste |
| curing | Viscosity (Pa · s) | 30 |
| After | Appearance | Black |
| curing | Hardness | >90 |
| | (Type A durometer) | |
| | Complex elastic modulus | 7 |
| | (GPa) | |
| | Coefficient of thermal | 6 |
| | expansion (ppm/° C.) | (Room temperature though 90° C.) |

Viscosity of the aforementioned curable epoxy resin composition was measured with the use of a BS-type rotary viscometer (the product of Tokimec Co., Ltd., Model BS, Rotor No. 7, frequency of rotation: 10 rpm). The measured values corresponded to 25° C. The curable epoxy resin composition was subjected to 5 min. compression molding under the load of 30 Kgf/cm² at 170° C., and heat treatment was carried out in an oven for 1 hour at 150° C. A composite modulus of elasticity in the obtained cured epoxy resin was measured with a viscoelasticity measurement instrument (shear frequency: 1 Hz; distortion factor: 0.5%). The measured values corresponded to 25° C. A coefficient of thermal expansion of the epoxy resin was measured within the range of temperatures between room temperature and 90° C. by means of a thermal mechanical analyzer (TMA).

### Comparative Example 2

A semiconductor device was produced by the same method as in Practical Example 3, except that a liquid curable epoxy resin composition with characteristics shown in Table 2 was used instead of a hydrosilylation reaction-curable silicone rubber composition (A) used in Practical Example 3. Compression-molding was carried out for 5 min. under the load of 30 kgf/cm² at a temperature of 170° C. with subsequent heat treatment for 1 hour in an oven at 150° C. The obtained semiconductor device was sealed with a 400 μm-thick epoxy resin coating on the surface of the semiconductor wafer. The surface of the epoxy resin coating was free of voids and was classified as grade ◯. However, warping on the surface of the aforementioned sealing epoxy was 6 mm.

### INDUSTRIAL APPLICABILITY

When a semiconductor device is sealed by the method of the present invention, it becomes possible to eliminate voids on the sealed surface, precisely control the thickness of the sealing layer, prevent breakage of the bonding wires and mutual contact between these wires, and to reduce warping of semiconductor chips and their printed-circuit boards. Semiconductor devices produced by the method of the present invention acquire improved properties described above.

1. A method of manufacturing a semiconductor device sealed with silicone rubber, characterized by
1) placing an unsealed semiconductor device into a mold,
2) thereafter filling in spaces between the mold and the semiconductor device with a sealing silicone rubber composition, and
3) subjecting the composition to compression molding.

2. The method of claim 1, wherein the mold comprises an upper mold and a lower mold, step 1) is performed by placing the unsealed semiconductor device into the lower mold, step 2) is performed by filling the spaces between the upper mold and the semiconductor device, and the unsealed semiconductor device is clamped between the upper mold and the lower mold after step 2) and before step 3).

3. The method of claim 1, wherein said silicone rubber composition is a hydrosilylation reaction-curable silicone rubber composition.

4. The method of claim 1, wherein said silicone rubber composition can be cured into a silicone rubber having a complex elastic modulus of 1 GPa or less.

5. The method of claim 1, wherein at least two unsealed semiconductor devices are sealed with the use of said silicone rubber, and then the sealed semiconductor devices are separated by cutting into individual sealed semiconductor devices.

6. The method of claim 1, wherein said semiconductor device comprises semiconductor chips on a printed-circuit board electrically interconnected via bonding wires.

7. The method of claim 6, wherein said silicone rubber composition is supplied to the semiconductor chips on the printed-circuit board, and connections between semiconductor chips and the bonding wires are sealed with the silicone rubber.

8. The method of claim 1, wherein inner surfaces of the mold are covered with an attached release film.

9. The method of claim 8, wherein said release film is attached to the inner surfaces of the mold by air suction.

10. A sealed semiconductor device produced by a method according to claim 1.
